(19) United States
(12) Patent Application Publication
(10) Pub. No.: US 2016/0077362 A1
(43) Pub. Date: Mar. 17, 2016

(54) LIQUID CRYSTAL OPTICAL DEVICE, CONTROL DEVICE OF LIQUID CRYSTAL OPTICAL DEVICE, AND IMAGE DISPLAY DEVICE

(71) Applicant: KABUSHIKI KAISHA TOSHIBA, Tokyo (JP)

(72) Inventors: Ayako TAKAGI, Yokosuka (JP); Shinichi UEHARA, Tokyo (JP); Masako KASHIWAGI, Yokohama (JP); Masahiro BABA, Yokohama (JP)

(21) Appl. No.: 14/848,789

(22) Filed: Sep. 9, 2015

(30) Foreign Application Priority Data
Sep. 12, 2014 (JP) 2014-186468

(51) Int. Cl. G02F 1/137; G02F 1/1343; G02B 27/22

(52) U.S. Cl. CPC G02F 1/137; G02B 27/2214; G02F 1/134309; G02F 2001/13706

(57) ABSTRACT

According to one embodiment, a liquid crystal optical device includes an optical unit and a controller. The optical unit includes first and second substrates, first electrodes, first and second counter electrodes, and a liquid crystal layer. The controller controls a voltage applied to the first electrodes, and the first and second counter electrodes. The controller performs a plurality of display modes based on at least one of image information and a control signal being obtained to forms a plurality of lens. The image information is inputted to an image display unit stacked with the optical unit and emits an image light.

### CROSS-REFERENCE TO RELATED APPLICATIONS

This application is based upon and claims the benefit of priority from Japanese Patent Application No. 2014-186468, filed on Sep. 12, 2014; the entire contents of which are incorporated herein by reference.

### FIELD

Embodiments described herein relate generally to a liquid crystal optical device, a control device of the liquid crystal optical device, and an image display device.

### BACKGROUND

There is a liquid crystal optical device in which the distribution of the refractive index is changed according to an applied voltage by utilizing the birefringence of a liquid crystal. In the liquid crystal optical device, the optical characteristics are controlled by a control device. There is an image display device in which an image display unit is combined with the liquid crystal optical device. The image display unit displays a two-dimensional image or a three-dimensional image including multiple parallax images. By changing the distribution of the refractive index of the liquid crystal optical device, a two-dimensional display and a three-dimensional display for stereoscopic viewing with the naked eyes are performed. An image display device having high display quality is desirable. A liquid crystal optical device having good optical characteristics is desirable.

### BRIEF DESCRIPTION OF THE DRAWINGS

FIG. 1 is a schematic view showing an image display device;

FIG. 2 is a schematic perspective view showing the image display device;

FIG. 3 is a schematic cross-sectional view showing the image display device;

FIGS. 4A and 4B are schematic cross-sectional views showing operations of the liquid crystal optical device;

FIG. 5 is a schematic plan view showing the liquid crystal optical device;

FIGS. 6A to 6D are schematic cross-sectional views showing operations of the liquid crystal optical device;

FIG. 7 shows conditions of the liquid crystal optical device;

FIGS. 8A to 8C are schematic cross-sectional views showing characteristics of the liquid crystal optical device;

FIG. 9 includes schematic cross-sectional views showing characteristics of the liquid crystal optical device;

FIGS. 10A to 10F are schematic plan views showing operations of the liquid crystal optical device;

FIGS. 11A to 11F are schematic plan views showing operations of the liquid crystal optical device;

FIGS. 12A and 12B are schematic plan views showing operations of the liquid crystal optical device;

FIGS. 13A and 13B are schematic plan views showing operations of the image display device;

FIG. 14A and FIG. 14B are schematic plan views showing operations of the image display device;

FIGS. 15A to 15D are schematic plan views showing operations of the image display device; and

FIG. 16 is a schematic cross-sectional view showing another image display device.

### DETAILED DESCRIPTION

According to one embodiment, a liquid crystal optical device includes an optical unit and a controller. The optical unit includes a first substrate, a second substrate, a plurality of first electrodes, a first counter electrode, a second counter electrode, and a liquid crystal layer. The first substrate has a first surface including a first region and a second region. The second substrate opposes the first substrate. The first electrodes are provided between the first substrate and the second substrate and arranged in a first direction parallel to the first surface. A first group of the first electrodes overlaps the first region. A second group of the first electrodes overlaps the second region when projected onto the first surface. The first counter electrode is provided between the second substrate and the first electrodes. The first counter electrode and the first region overlap when projected onto the first surface. The second counter electrode is provided between the second substrate and the first electrodes. The second counter electrode and the second region overlap when projected onto the first surface. The liquid crystal layer is provided between the first and the second substrates. The controller controls a voltage applied to the first electrodes, the first counter electrode, and the second counter electrode. The controller is configured to perform a plurality of display modes. The display modes include a first mode and a second mode. The first mode includes forming a first lens in the liquid crystal layer by forming a first potential difference between the first group and the first counter electrode and forming a second lens in the liquid crystal layer by forming a second potential difference between the second group and the second counter electrode. A difference between a maximum value and a minimum value of a refractive index of the first lens is larger than a difference between a maximum value and a minimum value of a refractive index of the second lens. The second mode includes forming a third lens in the liquid crystal layer by forming a third potential difference between the first group and the first counter electrode, and forming a fourth lens in the liquid crystal layer by forming a fourth potential difference between the second group and the second counter electrode. A difference between a maximum value and a minimum value of a refractive index of the third lens is larger than a difference between a maximum value and a minimum value of a refractive index of the fourth lens.

According to another embodiment, an image display device includes a liquid crystal optical device and an image display unit. The liquid crystal optical device includes an optical unit and a controller. The optical unit includes a first substrate, a second substrate, a plurality of first electrodes, a first counter electrode, a second counter electrode, and a liquid crystal layer. The first substrate has a first surface including a first region and a second region. The second substrate opposes the first substrate. The first electrodes are provided between the first substrate and the second substrate and arranged in a first direction parallel to the first surface. A first group of the first electrodes overlaps the first region. A second group of the first electrodes overlaps the second region when projected onto the first surface. The first counter electrode is provided between the second substrate and the first electrodes. The first counter electrode and the first region overlap when projected onto the first surface. The second counter electrode is provided between the second substrate and the first electrodes. The second counter electrode and the second region overlap when projected onto the first surface. The liquid crystal layer is provided between the first and the second substrates. The controller controls a voltage applied to the first electrodes, the first counter electrode, and the second counter electrode. The controller is configured to perform a plurality of display modes. The display modes include a first mode and a second mode. The first mode includes forming a first lens in the liquid crystal layer by forming a first potential difference between the first group and the first counter electrode and forming a second lens in the liquid crystal layer by forming a second potential difference between the second group and the second counter electrode. A difference between a maximum value and a minimum value of a refractive index of the first lens is larger than a difference between a maximum value and a minimum value of a refractive index the second lens. The second mode includes forming a third lens in the liquid crystal layer by forming a third potential difference between the first group and the first counter electrode and forming a fourth lens in the liquid crystal layer by forming a fourth potential difference between the second group and the second counter electrode. A difference between a maximum value and a minimum value of a refractive index of the third lens is larger than a difference between a maximum value and a minimum value of a refractive index of the fourth lens.

According to another embodiment, a control device controls a liquid crystal optical device. The liquid crystal optical device includes an optical unit including a first substrate, a second substrate, a plurality of first electrodes, a first counter electrode, a second counter electrode, and a liquid crystal layer. The first substrate has a first surface including a first region and a second region. The second substrate opposes the first substrate. The first electrodes are provided between the first substrate and the second substrate and arranged in a first direction parallel to the first surface. The first group of the first electrodes overlaps the first region. The second group of the first electrodes overlaps the second region when projected onto the first surface. The first counter electrode is provided between the second substrate and the first electrodes. The first counter electrode and the first region overlap when projected onto the first surface. A second counter electrode is provided between the second substrate and the first electrodes. The second counter electrode and the second region overlap when projected onto the first surface. The liquid crystal layer is provided between the first and the second substrates. The control device controls a voltage applied to the first electrodes, the first counter electrode, and the second counter electrode. The control device is configured to perform a plurality of display modes. The display modes include a first mode and a second mode. The first mode includes forming a first lens in the liquid crystal layer by forming a first potential difference between the first group and the first counter electrode, and forming a second lens in the liquid crystal layer by forming a second potential difference between the second group and the second counter electrode. A difference between a maximum value and a minimum value of a refractive index of the first lens is larger than a difference between a maximum value and a minimum value of a refractive index of the second lens. The second mode includes forming a third lens in the liquid crystal layer by forming a third potential difference between the first group and the first counter electrode, and forming a fourth lens in the liquid crystal layer by forming a fourth potential difference between the second group and the second counter electrode. A difference between a maximum value and a minimum value of a refractive index of the third lens is larger than a difference between a maximum value and a minimum value of a refractive index of the fourth lens.

Various embodiments will now be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

### First Embodiment

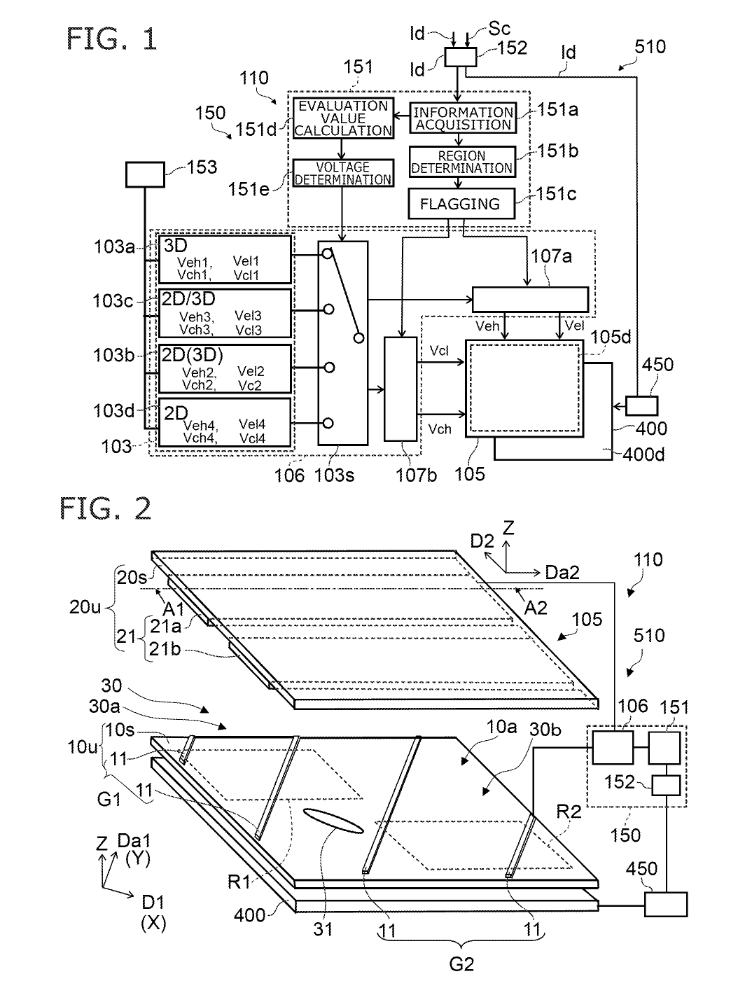

FIG. 1 is a schematic view illustrating an image display device according to a first embodiment.

The image display device 510 includes a liquid crystal optical device 110 and an image display unit 400. The liquid crystal optical device 110 includes an optical unit 105 and a controller 150 (a control device). The image display unit 400 is stacked with the optical unit 105. The image display unit 400 includes, for example, an image display drive unit 450.

In the specification of the application, the state of being stacked includes not only the state of overlapping in direct contact but also the state of being provided to overlap with spacing therebetween and the state of overlapping with another component inserted therebetween.

The controller 150 includes an input unit 152, a processor 151, a circuit unit 106, and a power supply unit 153.

For example, image information Id (an image signal) is input to the input unit 152. The image information Id is supplied to the image display drive unit 450. The image display unit 400 performs the display based on the image information Id. A control signal Sc may be further input to the input unit 152. The control signal Sc is, for example, a signal due to an operation of a user (a viewer).

The image information Id is supplied to the processor 151. The processor 151 performs processing based on the image information Id. The circuit unit 106 operates based on the processing result of the processor 151.

The circuit unit 106 includes, for example, a voltage generator 103, a switch circuit 103s, a first circuit unit 107a, and a second circuit unit 107b. For example, the voltage generator 103 generates multiple potentials from the voltage (the electrical power) supplied from the power supply unit 153. In the example, the voltage generator 103 includes first to fourth voltage generators 103a to 103d.

For example, the first voltage generator 103a generates a first electrode high potential Veh1, a first electrode low potential Vel1, a first counter high potential Vch1, and a first counter low potential Vc11.

For example, the second voltage generator 103b generates a second electrode high potential Veh2, a second electrode low potential Vel2, a second counter high potential Vch2, and a second counter low potential Vcl2.

For example, the third voltage generator 103c generates a third electrode high potential Veh3, a third electrode low potential Vel3, a third counter high potential Vch3, and a third counter low potential Vcl3.

For example, the fourth voltage generator 103d generates a fourth electrode high potential Veh4, a fourth electrode low potential Vel4, a fourth counter high potential Vch4, and a fourth counter low potential Vcl4. The fourth electrode high potential Veh4, the fourth electrode low potential Vel4, the fourth counter high potential Vch4, and the fourth counter low potential Vcl4 may be 0 volts (V).

The switch circuit 103s switches between these potentials and supplies these potentials to the first circuit unit 107a and the second circuit unit 107b. The first circuit unit 107a supplies a high voltage Veh and a low voltage Vel to the optical unit 105. The second circuit unit 107b supplies a high common voltage Vch and a low common voltage Vcl to the optical unit 105. As described below, the distribution of the refractive index in a light control region 105d of the optical unit 105 changes according to these voltages.

The processor 151 includes an information acquisition unit 151a, a region determination unit 151b, a flagging unit 151c, an evaluation value calculator 151d, and a voltage determination unit 151e. The information acquisition unit 151a acquires the image information Id (information of the display content). The region determination unit 151b determines the region inside the display region where a three-dimensional (3D) image is displayed. For example, a region (a 2D region) where a two-dimensional (2D) image is displayed and a region (a 3D region) where a three-dimensional image is displayed are provided inside a screen 400d of the image display unit 400. The region determination unit 151b determines these regions. The flagging unit 151c provides flag bits in the row direction and column direction of the light control region 105d. This is described below. The evaluation value calculator 151d calculates an evaluation value (a weight) for the 2D region and the 3D region based on the display content. The voltage determination unit 151e determines, based on the evaluation value, appropriate combinations from the combinations of the various potentials generated by the voltage generator 103. The switch circuit 103s switches the potentials according to the determination of the voltage determination unit 151e.

The information acquisition unit 151a, the region determination unit 151b, the flagging unit 151c, the evaluation value calculator 151d, and the voltage determination unit 151e are a functional block and correspond to the processing implemented by the processor 151. At least a portion of the processing may be implemented simultaneously or may be implemented at different times. The processor 151 includes, for example, a semiconductor integrated circuit, etc.

FIG. 2 is a schematic perspective view illustrating the liquid crystal optical device according to the first embodiment.

As shown in FIG. 2, the optical unit 105 includes a first substrate unit 10u, a second substrate unit 20u, and a liquid crystal layer 30.

The first substrate unit 10u includes a first substrate 10s and multiple first electrodes 11.

The first substrate 10s is light-transmissive. The first substrate 10s has a first surface 10a. The first surface 10a includes, for example, a first region R1 and a second region R2.

The multiple first electrodes 11 are arranged in a first direction D1. The first direction D1 is one direction parallel to the first surface 10a.

A direction perpendicular to the first surface 10a is taken as a Z-axis direction. One direction perpendicular to the Z-axis direction is taken as an X-axis direction. A direction perpendicular to the Z-axis direction and perpendicular to the X-axis direction is taken as a Y-axis direction. The first direction D1 is, for example, the X-axis direction.

For example, each of the multiple first electrodes 11 extends along a first orthogonal direction Da1. The first orthogonal direction Da1 is, for example, the Y-axis direction. The multiple first electrodes 11 include a first group G1 and a second group G2. The first region R1 and a portion of the first group G1 overlap when projected onto the first surface 10a. The second region R2 and a portion of the second group G2 overlap when projected onto the first surface 10a.

The second substrate unit 20u includes a second substrate 20s and counter electrodes 21. The counter electrodes 21 include a first counter electrode 21a and a second counter electrode 21b.

The second substrate 20s is light-transmissive. The multiple first electrodes 11 are disposed between the first substrate 10s and the second substrate 20s.

The first counter electrode 21a is provided between the first substrate unit 10u and the second substrate 20s. The first region R1 and a portion of the first counter electrode 21a overlap when projected onto the first surface 10a.

The second counter electrode 21b is provided between the first substrate unit 10u and the second substrate 20s. The second region R2 and a portion of the second counter electrode 21b overlap when projected onto the first surface 10a. The second counter electrode 21b is separated from the first counter electrode 21a in a second direction D2. The second direction D2 is parallel to the first surface 10a and intersects the first direction D1.

Thus, the multiple counter electrodes 21 are provided. The multiple counter electrodes 21 are arranged in the second direction D2. Each of the multiple counter electrodes 21 extends along a second orthogonal direction Da2. The second orthogonal direction Da2 is perpendicular to the second direction D2. The second direction D2 may be perpendicular to the first direction D1 or may be tilted with respect to the first direction D1.

The liquid crystal layer 30 is provided between the first substrate unit 10u and the second substrate unit 20u. The liquid crystal layer 30 includes a first liquid crystal region 30a and a second liquid crystal region 30b. The first liquid crystal region 30a and the first region R1 overlap when projected onto the first surface 10a. The second liquid crystal region 30b and the second region R2 overlap when projected onto the first surface 10a.

The liquid crystal layer 30 includes a liquid crystal 31; and the liquid crystal 31 includes, for example, a nematic liquid crystal. For example, the long axis (the director) of the liquid crystal 31 has a component parallel to the first direction D1 when projected onto the first surface 10a. The dielectric anisotropy of the liquid crystal 31 may be positive or negative.

The controller 150 is electrically connected to the multiple first electrodes 11, the first counter electrode 21a, and the second counter electrode 21b.

In the specification of the application, the state of being electrically connected includes the state in which multiple conductors are in direct contact. The state of being electrically connected includes the state in which multiple conductors are connected via another conductor and a current flows between the multiple conductors. The state of being electrically connected includes the state in which it is possible to form a state in which multiple conductors are connected via a switch element (e.g., a transistor, etc.) and a current flows between the multiple conductors.

The first substrate 10s and the second substrate 20s include, for example, a transparent glass substrate or a transparent resin substrate.

The first electrode 11 and the counter electrode 21 include transparent conductive films. These electrodes include oxides including at least one element selected from the group consisting of In, Sn, Zn, and Ti. At least a portion of these electrodes includes, for example, an indium tin oxide (ITO) film. A supplemental interconnect may be provided for each of these electrodes. The supplemental interconnect includes, for example, a metal; and a low resistance is obtained.

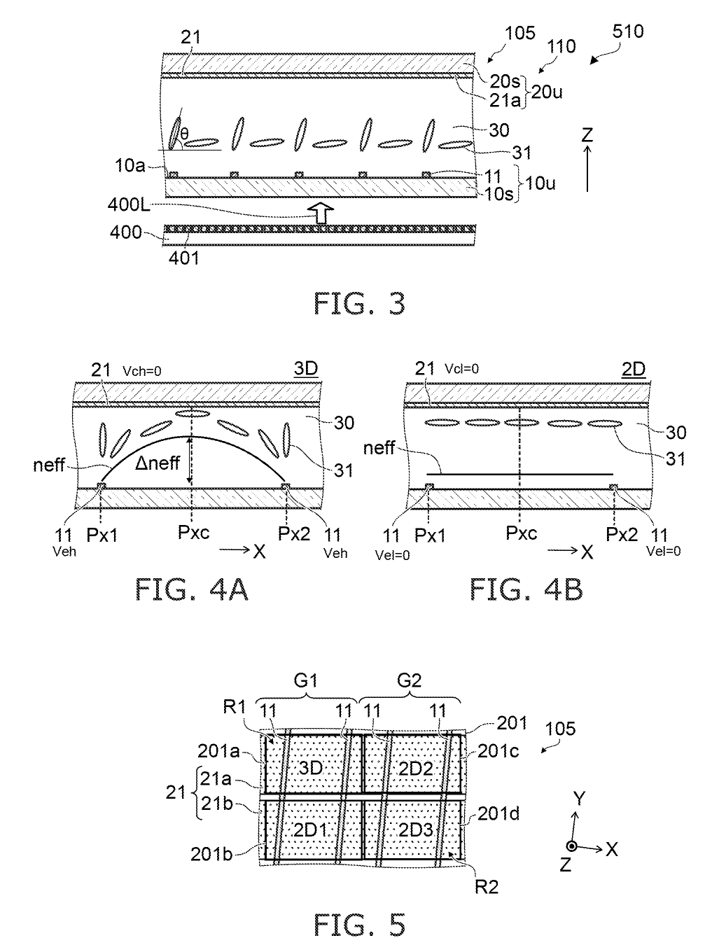

FIG. 3 is a schematic cross-sectional view illustrating the liquid crystal optical device and the image display device according to the first embodiment.

FIG. 3 is a cross-sectional view along line A1-A2 of FIG. 2.

As shown in FIG. 3, the image display unit 400 emits image light 400L. Multiple pixels 401 are provided in the image display unit 400. Each of the pixels 401 emits light corresponding to the image information Id. The light that is emitted is the image light 400L.

A tilt angle θ is the angle between the first surface 10a and the long axis of the liquid crystal 31 of the liquid crystal layer 30. In the case where the dielectric anisotropy of the liquid crystal 31 of the liquid crystal layer 30 is positive, the angle (the pretilt angle) between the first surface 10a and the long axis of the liquid crystal 31 for the initial alignment of the liquid crystal layer 30 is small. The pretilt angle is not less than 0 degrees and not more than 30 degrees. The tilt angle θ of the liquid crystal 31 in the region between the first electrodes 11 and the counter electrodes 21 becomes large when an applied voltage (greater than a threshold voltage) is applied between the first electrodes 11 and the counter electrodes 21. The tilt angle θ is substantially maintained at the pretilt angle in the liquid crystal 31 between the counter electrode 21 and the region between the multiple first electrodes 11. A distribution is formed in the alignment of the liquid crystal of the liquid crystal layer 30. In other words, regions where the tilt angle θ is large are formed; and regions where the tilt angle θ is small are formed.

The liquid crystal 31 has birefringence. A refractive index no (the refractive index of ordinary light) in the short-axis direction of the liquid crystal 31 is less than a refractive index ne (the refractive index of extraordinary light) in the long-axis direction of the liquid crystal 31.

The effective refractive index of the liquid crystal layer 30 changes according to the distribution of the tilt angle θ of the liquid crystal of the liquid crystal 31. For example, the effective refractive index n(θ) is expressed by ne·no/(ne²·sin²(θ)+no²·cos²(θ))^{1/2}. The effective refractive index n(θ) changes due to the tilt angle θ changing according to the applied voltage. Because the tilt angle θ when applying the voltage changes along the Z-axis direction of the liquid crystal layer 30, the value of the integration along the Z-axis direction of the formula recited above corresponds to the effective refractive index n.

In the case where the dielectric anisotropy of the liquid crystal 31 of the liquid crystal layer 30 is negative, the pretilt angle is set to be large for the initial alignment of the liquid crystal layer 30. For example, a vertical alignment is applied. The pretilt angle is not less than 60 degrees and not more than 90 degrees. The tilt angle θ of the liquid crystal 31 in the region between the first electrodes 11 and the counter electrodes 21 becomes small when the applied voltage is applied between the first electrodes 11 and the counter electrodes 21. At this time as well, regions where the tilt angle θ is large are formed; and regions where the tilt angle θ is small are formed. Thereby, the effective refractive index of the liquid crystal layer 30 changes.

To simplify the description hereinbelow, the case is described where the dielectric anisotropy of the liquid crystal 31 is positive. The description hereinbelow is applicable in the case where the dielectric anisotropy is negative by reversing the absolute value of the voltage (the potential difference).

FIGS. 4A and 4B are schematic cross-sectional views illustrating operations of the liquid crystal optical device according to the first embodiment.

As shown in FIG. 4A, the high voltage Veh is applied to the first electrodes 11; and the low common voltage Vcl is applied to the counter electrode 21. The high voltage Veh is, for example, 3 V or more and is greater than the threshold of the liquid crystal 31. The low common voltage Vcl is, for example, 0 V. The tilt angle θ of the liquid crystal 31 becomes large at the position (a first position Px1) of one first electrode 11 and the position (a second position Px2) of one other first electrode 11. The tilt angle θ is small at the middle (a center position Pxc) between these positions. Thereby, the effective refractive index neff changes along the X-axis direction. A difference Δneff between the maximum value and the minimum value of the refractive index neff is large. For example, a cylindrical lens that extends along a direction intersecting the X-axis direction is formed. Namely, a GRIN (Gradient Index) lens is formed.

As shown in FIG. 4B, the low voltage Vel is applied to the first electrodes 11; and the low common voltage Vcl is applied to the counter electrode 21. The low voltage Vel and the low common voltage Vcl are, for example, 0 V. The tilt angle θ of the liquid crystal 31 is maintained at the pretilt angle; and the initial alignment is maintained. At this time, the refractive index neff is uniform.

For example, the image light 400L that includes multiple parallax images is emitted from the image display unit 400. In such a case, the refractive index neff is changed as shown in FIG. 4A. Thereby, the travel direction of the image light 400L is modified. The image light 400L that corresponds to the multiple parallax images is incident on the left and right eyes of the viewer. The viewer perceives a three-dimensional display.

For example, the image light 400L that does not include parallax is emitted from the image display unit 400. In such a case, the refractive index neff is set to be uniform as shown in FIG. 4B. The image light 400L is incident on the left and right eyes of the viewer substantially without the travel direction changing. The viewer perceives a two-dimensional display.

In the image display device 510, an image (a 3D image) that includes multiple parallax images is displayed in a portion (a 3D region) of the screen 400d; and an image (a 2D image) that does not include parallax is displayed in one other portion (a 2D region) of the screen 400d. To correspond to these regions in the liquid crystal optical device 110, a region where a GRIN lens is formed and a region where a GRIN lens substantially is not formed are provided.

At least a portion of the region where the GRIN lens is formed corresponds to the first region R1. At least a portion of the region where the change of the refractive index neff is small (the region where the GRIN lens substantially is not formed) corresponds to the second region R2.

FIG. 5 is a schematic plan view illustrating the liquid crystal optical device according to the first embodiment.

As shown in FIG. 5, the region (a region 201a) where the first group G1 and the first counter electrode 21a overlap corresponds to the first region R1. The region (a region 201d) where the second group G2 and the second counter electrode 21b overlap corresponds to the second region R2.

The region 201a where the first group G1 and the first counter electrode 21a overlap corresponds to the region where the 3D image is displayed. The region 201d where the second group G2 and the second counter electrode 21b overlap corresponds to the region where the 2D image is displayed. A region 201b where the first group G1 and the second counter electrode 21b overlap corresponds to the region where the 2D image is displayed. A region 201c where the second group G2 and the first counter electrode 21a overlap corresponds to the region where the 2D image is displayed.

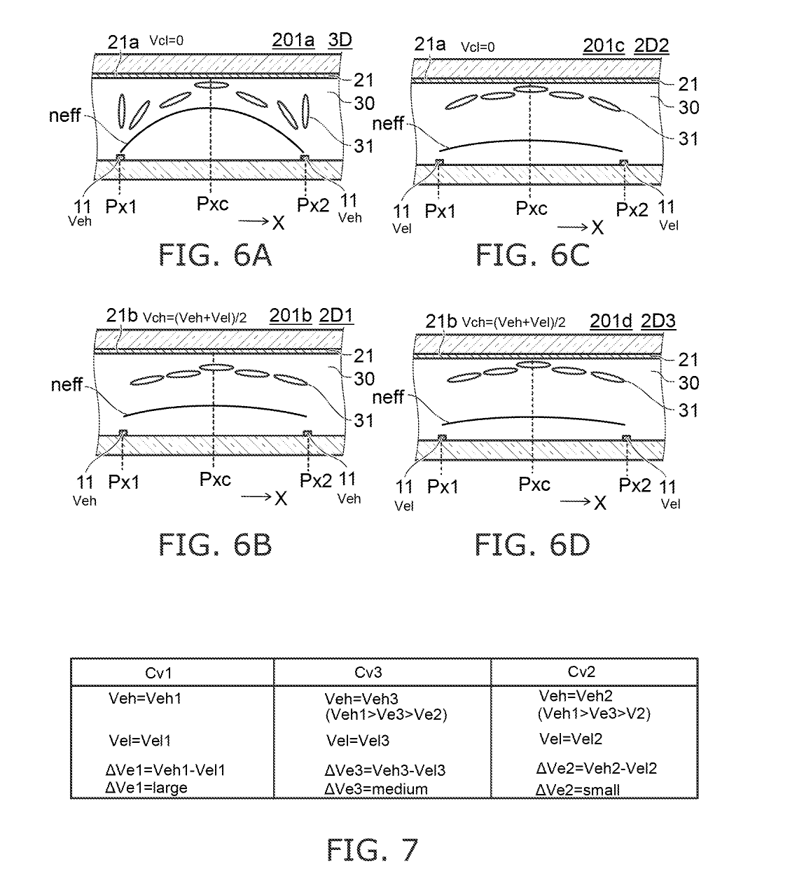

FIGS. 6A to 6D are schematic cross-sectional views illustrating operations of the liquid crystal optical device according to the first embodiment.

In the region 201a as shown in FIG. 6A, the high voltage Veh is applied to the first electrodes 11 (the first group G1). The low common voltage Vcl is applied to the first counter electrode 21a. The voltage that is applied to the liquid crystal layer 30 is high. Thereby, in the region 201a, the refractive index neff changes; and a GRIN lens is formed.

In the region 201b as shown in FIG. 6B, the high voltage Veh is applied to the first electrodes 11 (the first group G1). The high common voltage Vch is applied to the second counter electrode 21b. The high common voltage Vch is, for example, a voltage between the high voltage Veh and the low voltage Vel. The high common voltage Vch is taken to be (Veh+Vel)/2. In the region 201b, the voltage that is applied to the liquid crystal layer 30 is small; and the change of the refractive index neff is small.

In the region 201c as shown in FIG. 6C, the low voltage Vel is applied to the first electrodes 11 (the second group G2). The low common voltage Vcl is applied to the first counter electrode 21a. In the region 201c, the voltage that is applied to the liquid crystal layer 30 is small; and the change of the refractive index neff is small.

In the region 201d as shown in FIG. 6D, the low voltage Vel is applied to the first electrodes 11 (the second group G2). The high common voltage Vch is applied to the second counter electrode 21b. In the region 201d, the voltage that is applied to the liquid crystal layer 30 is small; and the change of the refractive index neff is small.

Thus, the region is formed where the GRIN lens corresponding to the 3D image is formed; and the region is formed where the change of the refractive index neff is small to correspond to the 2D image.

Crosstalk occurs in the region where the first group G1, the second group G2, the first counter electrode 21a, and the second counter electrode 21b are formed. The crosstalk and the difference Δneff between the maximum value and minimum value of the refractive index neff change due to the voltage supplied to these electrodes.

An example of characteristics of the liquid crystal layer 30 when the high voltage Veh, the low voltage Vel, the high common voltage Vch, and the low common voltage Vcl are changed will now be described.

FIG. 7 illustrates conditions of the liquid crystal optical device according to the first embodiment.

In a first condition Cv1 as shown in FIG. 7, the high voltage Veh is set to the first electrode high potential Veh1. The low voltage Vel is set to the first electrode low potential Vel1. The high common voltage Vch is set to the first counter high potential Vch1. The first counter high potential Vch1 is, for example, (Veh1+Vel1)/2. The low common voltage Vcl is set to the first counter low potential Vcl1 (e.g., 0 V). A difference ΔVe1 between the first electrode high potential Veh1 and the first electrode low potential Vel1 is set to be large.

In a second condition Cv2, the high voltage Veh is set to the second electrode high potential Veh2. The low voltage Vel is set to the second electrode low potential Vel2. The second electrode high potential Veh2 is lower than the first electrode high potential Veh1. The high common voltage Vch is set to the second counter high potential Vch2. The second counter high potential Vch2 is, for example, (Veh2+Vel2)/2. The low common voltage Vcl is set to the second counter low potential Vcl2 (e.g., 0 V). A difference ΔVe2 between the second electrode high potential Veh2 and the second electrode low potential Vel2 is small. The difference ΔVe2 is smaller than the difference ΔVe1.

In a third condition Cv3, the high voltage Veh is set to the third electrode high potential Veh3. The low voltage Vel is set to the third electrode low potential Vel3. The third electrode high potential Veh3 is between the first electrode high potential Veh1 and the second electrode high potential Veh2. The high common voltage Vch is set to the third counter high potential Vch3. The third counter high potential Vch3 is, for example, (Veh3+Vel3)/2. The low common voltage Vcl is set to the third counter low potential Vcl3 (e.g., 0 V). A difference ΔVe3 between the third electrode high potential Veh3 and the third electrode low potential Vel3 is medium. The difference ΔVe3 is between the difference ΔVe1 and the difference ΔVe2.

For example, Veh1−Vel1≧Veh3−Vel3≧Veh2−Vel2.

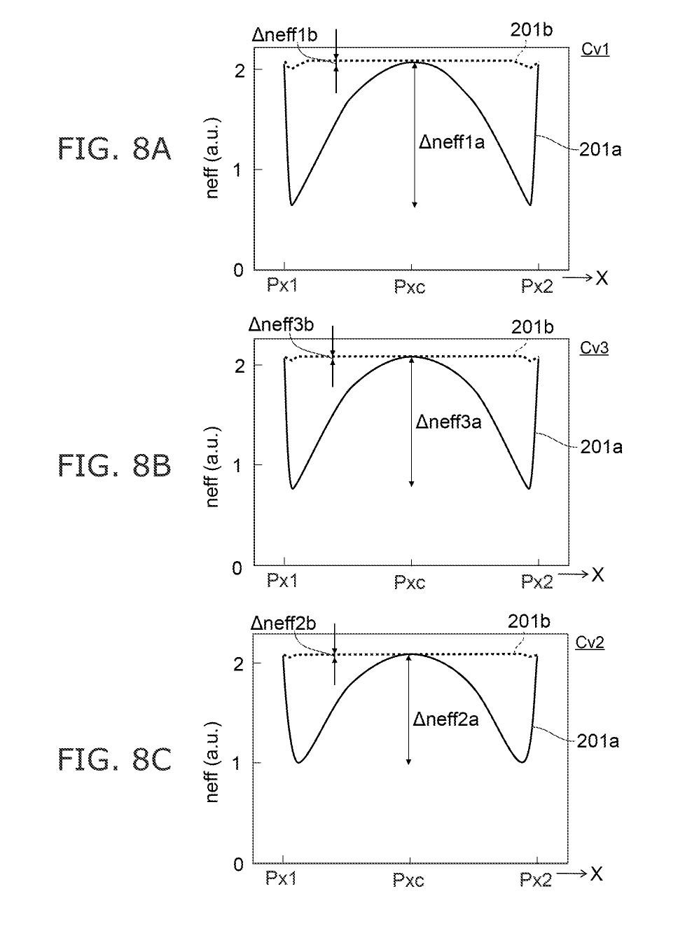

FIGS. 8A to 8C are schematic cross-sectional views illustrating characteristics of the liquid crystal optical device according to the first embodiment.

FIGS. 8A to 8C correspond respectively to the first to third conditions Cv1 to Cv3. In these drawings, the horizontal axis is the X-axis direction position. The vertical axis is the effective refractive index neff of the liquid crystal layer 30. The solid line corresponds to the characteristic of the region 201a. The broken line corresponds to the characteristic of the region 201b. These drawings illustrate simulation results.

For the first condition Cv1 as shown in FIG. 8A, the refractive index neff changes greatly in the region 201a. A difference Δneff1a between the maximum value and minimum value of the refractive index neff is large. On the other hand, in the region 201b, a difference Δneff1b between the maximum value and minimum value of the refractive index neff is smaller than the difference Δneff1a. In the region 201b, the refractive index neff changes in the region (the lens edge region) at the vicinity of the first position Px1 and the second position Px2. The change is relatively large. A large lens effect is obtained for the first condition Cv1. The first condition Cv1 is suited to the 3D image.

For the second condition Cv2 as shown in FIG. 8C, a difference Δneff2a between the maximum value and minimum value of the refractive index neff is small in the region 201a. On the other hand, in the region 201b, a difference Δneff2b between the maximum value and minimum value of the refractive index neff is smaller than the difference Δneff2a. In the region 201b, the change of the refractive index neff in the lens edge region is relatively small. The second condition Cv2 is suited to the 2D image.

For the third condition Cv3 as shown in FIG. 8B, a difference Δneff3a between the maximum value and minimum value of the refractive index neff is about medium in the region 201a. On the other hand, in the region 201b, a difference Δneff3b between the maximum value and minimum value of the refractive index neff is smaller than the difference Δneff3a. In the region 201b, the change of the refractive index neff in the lens edge region is about medium. The third condition Cv3 is a medium condition balanced between the 2D image and the 3D image.

The characteristics of the region 201c and the region 201d are similar to the characteristics of the region 201b.

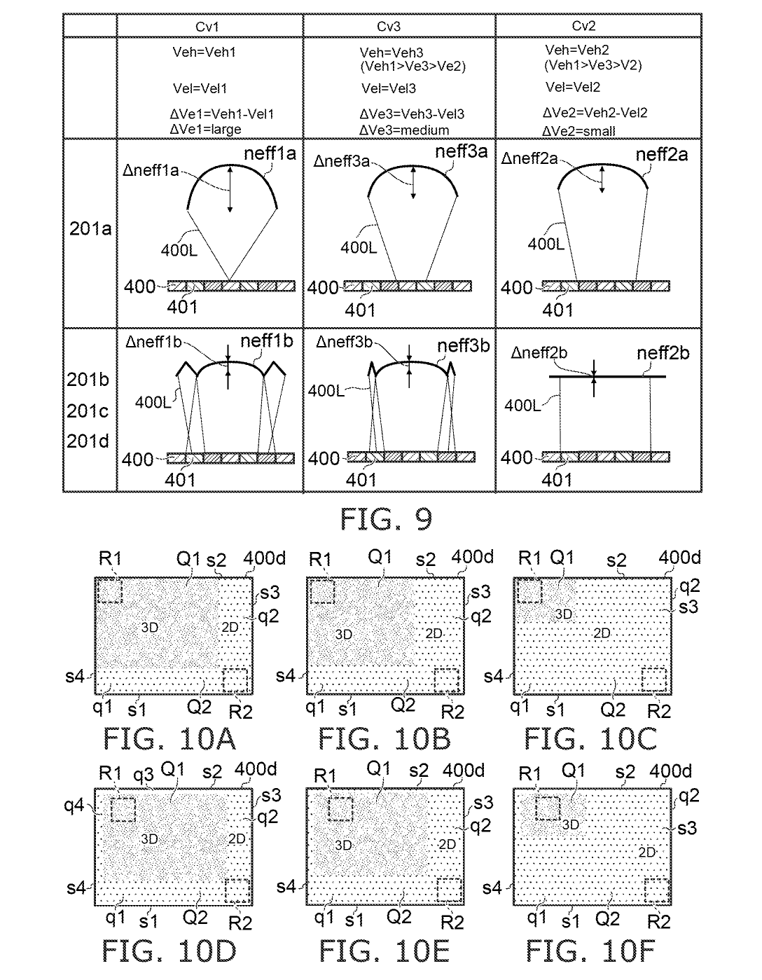

FIG. 9 includes schematic cross-sectional views illustrating characteristics of the liquid crystal optical device according to the first embodiment.

In the region 201a as shown in FIG. 9, the difference Δneff1a is large for the first condition Cv1. For example, the position of the focal point of the lens formed by the distribution of the refractive index neff (a first large refractive index distribution neff1a, i.e., the first lens) formed in the liquid crystal layer 30 substantially corresponds to the position of the image display unit 400. Thereby, for example, the 3D image separately reaches the left and right eyes of the viewer. For the second condition Cv2, the focal length is longer because the difference Δneff2a of the distribution of the refractive index neff (a second large refractive index distribution neff2a, i.e., the third lens) is small. Therefore, the separation of the 3D image is insufficient. For the third condition Cv3, the characteristic of the distribution of the refractive index neff (a third large refractive index distribution neff3a, i.e., the fifth lens) is medium between the first condition Cv1 and the second condition Cv2.

On the other hand, the differences Δneff1b, Δneff2b, and Δneff3b between the maximum value and minimum value of the refractive index neff of the refractive index distributions (a first small refractive index distribution neff1b, a second small refractive index distribution neff2b, and a third small refractive index distribution neff3b) are small in the regions 201b, 201c, and 201d for the first condition Cv1, the second condition Cv2, and the third condition Cv3. For the first condition Cv1, the change of the refractive index neff in the lens edge region is large; and the display of the 2D image is thereby difficult to view. For the second condition Cv2, the change of the refractive index neff in the lens edge region is small; and the display of the 2D image is thereby easy to view. For the third condition Cv3, the characteristics are medium between the first condition Cv1 and the second condition Cv2. For example, the first small refractive index distribution may be called a second lens for convenience. However, the refractive index of the first small refractive index distribution may be substantially constant. For example, the second small refractive index distribution may be called a fourth lens for convenience. However, the refractive index of the second small refractive index distribution may be substantially constant. For example, the third small refractive index distribution may be called a sixth lens for convenience. However, the refractive index of the third small refractive index distribution may be substantially constant.

The first condition Cv1 is a 3D preferential condition. The second condition Cv2 is a 2D preferential condition. The third condition Cv3 is a medium condition.

In the embodiment, the first condition Cv1 and the second condition Cv2 recited above are used by switching between the conditions based on the image information Id and the control signal Sc (e.g., the input signal from the viewer, etc.) that is acquired. The third condition Cv3 also may be used by switching to the third condition Cv3.

In other words, the controller 150 implements the selecting operation based on at least one of the image information Id or the control signal Sc that is acquired. The selecting operation includes selectively implementing one of a first operation (a first mode) or a second operation (a second mode) recited below.

The first operation includes forming the refractive index distribution (the first large refractive index distribution neff1a) in the region 201a (the first liquid crystal region 30a) and forming the refractive index distribution (the first small refractive index distribution neff1b) in the region 201c (the second liquid crystal region 30b). The difference Δneff1a between the maximum value and minimum value of the refractive index of the first liquid crystal region 30a of the first large refractive index distribution neff1a is larger than the difference Δneff1b between the maximum value and minimum value of the refractive index of the second liquid crystal region 30b of the first small refractive index distribution neff1b. The refractive index neff of the first small refractive index distribution neff1b substantially may not change.

The first large refractive index distribution neff1a is formed by forming a potential difference having a first absolute value between the first group G1 and the first counter electrode 21a.

The first small refractive index distribution neff1b is formed by forming a potential difference having a second absolute value between the second group G2 and the second counter electrode 21b. The second absolute value is different from the first absolute value.

For example, the first operation includes setting the first group G1 to the first electrode high potential Veh1, setting the first counter electrode 21a to the first counter low potential Vc11, setting the second group G2 to the first electrode low potential Vel1, and setting the second counter electrode 21 to the first counter high potential Vch1. By setting these potentials, the potential difference having the first absolute value and the potential difference having the second absolute value recited above are formed; and the refractive index distribution recited above is formed.

The second operation includes forming the refractive index distribution (the second large refractive index distribution neff2a) in the region 201a (the first liquid crystal region 30a) and forming the refractive index distribution (the second small refractive index distribution neff2b) in the region 201c (the second liquid crystal region 30b). The difference Δneff2a between the maximum value and minimum value of the refractive index of the first liquid crystal region 30a of the second large refractive index distribution neff2a is larger than the difference Δneff2b between the maximum value and minimum value of the refractive index of the second liquid crystal region 30b of the second small refractive index distribution neff2b. The refractive index neff of the second small refractive index distribution neff2b substantially may not change.

The second large refractive index distribution neff2a is formed by forming a potential difference having a third absolute value between the first group G1 and the first counter electrode 21a.

The second small refractive index distribution neff2b is formed by forming a potential difference having a fourth absolute value between the second group G2 and the second counter electrode 21b. The fourth absolute value is different from the third absolute value.

For example, the second operation includes setting the first group G1 to the second electrode high potential Veh2, setting the first counter electrode 21a to the second counter low potential Vcl2, setting the second group G2 to the second electrode low potential Vel2, and setting the second counter electrode 21b to the second counter high potential Vch2. By setting these potentials, the potential difference having the third absolute value and the potential difference having the fourth absolute value recited above are formed; and the refractive index distribution recited above is formed.

The difference Δneff1a between the maximum value and minimum value of the refractive index of the first liquid crystal region 30a of the first large refractive index distribution neff1a is larger than the difference Δneff2a between the maximum value and minimum value of the refractive index of the first liquid crystal region 30a of the second large refractive index distribution neff2a.

The first operation uses the first condition Cv1. The second operation uses the second condition Cv2. The first operation uses the 3D preferential condition. The second operation uses the 2D preferential condition.

In the embodiment, one of the first operation or the second operation is selectively implemented based on the image information Id and the control signal Sc (e.g., the input signal from the viewer or the like) that is acquired. For example, the 3D preferential operation is implemented in the case where attention is being given to the content of the image information Id on the 3D display. For example, the 2D preferential operation is implemented in the case where attention is being given to the content of the image information Id on the 2D display.

According to the embodiment, the operation is switched between an operation suited to the 3D display and an operation suited to the 2D display. Thereby, a liquid crystal optical device having good optical characteristics and an image display device having high display quality can be provided.

In the embodiment, the controller 150 may further implement a third operation (a third mode). For example, the third operation uses the third condition Cv3.

The third operation includes forming the third large refractive index distribution neff3a in the first liquid crystal region 30a and forming the third small refractive index distribution neff3b in the second liquid crystal region 30b. The difference Δneff3a between the maximum value and minimum value of the refractive index of the first liquid crystal region 30a of the third large refractive index distribution neff3a is larger than the difference Δneff3b between the maximum value and minimum value of the refractive index of the second liquid crystal region 30b of the third small refractive index distribution neff3b.

The third large refractive index distribution neff3a is formed by forming a potential difference having a fifth absolute value between the first group G1 and the first counter electrode 21a.

The third small refractive index distribution neff3b is formed by forming a potential difference having a sixth absolute value between the second group G2 and the second counter electrode 21b. The sixth absolute value is different from the fifth absolute value. The fifth absolute value is between the first absolute value and the third absolute value.

For example, the third operation includes setting the first group G1 to the third electrode high potential Veh3, setting the first counter electrode 21a to the third counter low potential Vcl3, setting the second group G2 to the third electrode low potential Vel3, and setting the second counter electrode 21b to the third counter high potential Vch3.

For example, the case where the dielectric anisotropy of the liquid crystal 31 included in the liquid crystal layer 30 is positive is as follows. The first absolute value is greater than the second absolute value. The third absolute value is greater than the fourth absolute value. The first absolute value is greater than the third absolute value.

For example, the case where the dielectric anisotropy of the liquid crystal 31 included in the liquid crystal layer 30 is negative is as follows. The first absolute value is less than the second absolute value. The third absolute value is less than the fourth absolute value. The first absolute value is less than the third absolute value.

Examples of the first operation, the second operation, and the third operation of the liquid crystal optical device 110 will now be described. FIGS. 10A to 10F are schematic plan views illustrating operations of the image display device according to the first embodiment.

As shown in FIG. 10A, a first display region Q1 and a second display region Q2 are provided in the screen 400d of the image display unit 400. The first display region Q1 emits the image light 400L (a first image light, i.e., the 3D image) including multiple parallax. The second display region Q2 emits the image light 400L (a second image light, i.e., the 2D image) not including parallax.

The first region R1 and at least a portion of the first display region Q1 overlap when projected onto the first surface 10a. The second region R2 and at least a portion of the second display region Q2 overlap when projected onto the first surface 10a.

The screen 400d has first to fourth sides si to s4. The second side s2 is separated from the first side s1. The third side s3 intersects the first side s1 and the second side s2. The fourth side s4 is separated from the third side s3 and intersects the first side si and the second side s2.

In the examples of FIGS. 10A to 10F, a portion (a first portion q1) of the second display region Q2 is disposed between the first display region Q1 and the first side s1. Another portion (a second portion q2) of the second display region Q2 is disposed between the first display region Q1 and the third side s3.

In the examples of FIGS. 10D to 10F, a portion (a third portion q3) of the second display region Q2 is disposed between the first display region Q1 and the second side s2. Another portion (a fourth portion q4) of the second display region Q2 is disposed between the first display region Q1 and the fourth side s4.

In the examples of FIGS. 10A and 10D, the surface area (a first surface area) of the first display region Q1 is greater than the surface area (a second surface area) of the second display region Q2. For example, for this condition, the first operation (the 3D preferential operation) is implemented.

In the examples of FIG. 10C and FIG. 10F, the surface area (the first surface area) of the first display region Q1 is less than the surface area (the second surface area) of the second display region Q2. For example, for this condition, the second operation (the 2D preferential operation) is implemented.

In the examples of FIG. 10B and FIG. 10E, the surface area (the first surface area) of the first display region Q1 is substantially the same as the surface area (the second surface area) of the second display region Q2. For example, for this condition, the third operation (the medium operation) is implemented.

For example, a threshold (a first surface area threshold) is determined for the proportion of the surface area. The controller 150 implements the first operation when the ratio of the first surface area of the first display region Q1 to the second surface area of the second display region Q2 is greater than the first surface area threshold. The controller 150 implements the second operation when the ratio is not more than the first surface area threshold.

The third operation may be implemented as necessary. In such a case, for example, a second surface area threshold is determined for the proportion of the surface area. The second surface area threshold is less than the first surface area threshold. The controller 150 implements the first operation when the ratio of the first surface area of the first display region Q1 to the second surface area of the second display region Q2 is greater than the first surface area threshold. The controller implements the third operation when the ratio is not more than the first surface area threshold and greater than the second surface area threshold. The controller 150 implements the second operation when the ratio is not more than the second surface area threshold.

Thus, the controller 150 implements the operation by switching the operation according to the surface area of the 3D image and the surface area of the 2D image.

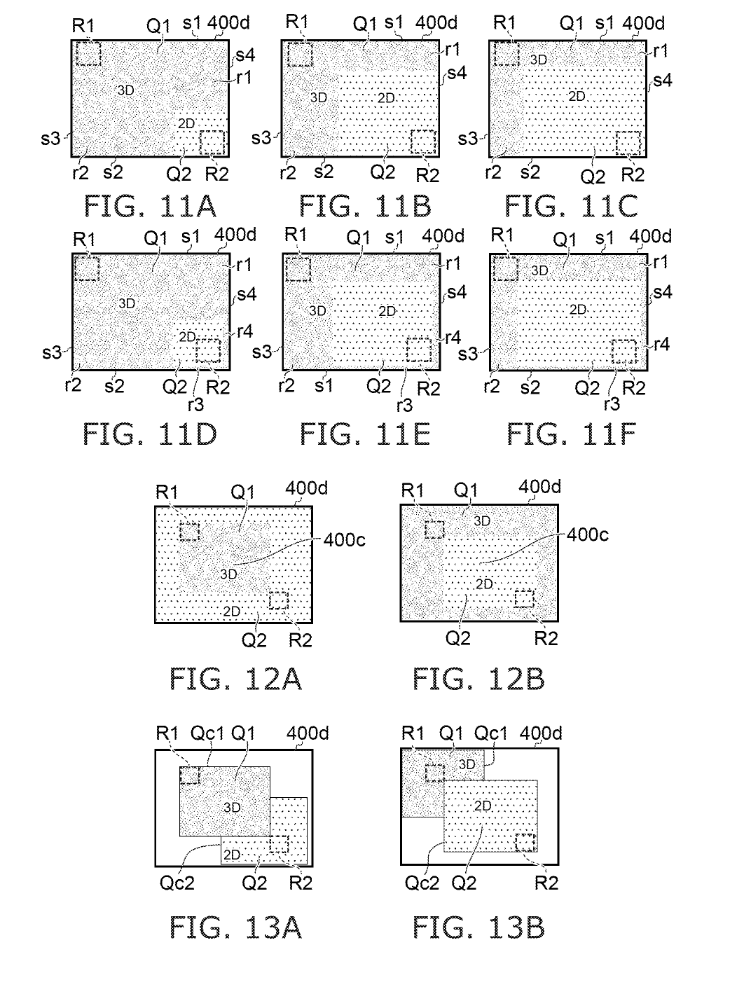

FIGS. 11A to 11F are schematic plan views illustrating operations of the image display device according to the first embodiment.

In such cases as well, the first display region Q1 and the second display region Q2 are provided in the screen 400d of the image display unit 400.

In the examples of FIGS. 11A to 11F, a portion (a first portion r1) of the first display region Q1 is disposed between the second display region Q2 and the first side s1. Another portion (a second portion r2) of the first display region Q1 is disposed between the second display region Q2 and the third side s3.

In the examples of FIGS. 11D to 11F, another portion (a third portion r3) of the first display region Q1 is disposed between the second display region Q2 and the second side s2. Another portion (a fourth portion r4) of the first display region Q1 is disposed between the second display region Q2 and the fourth side s4.

In the examples of FIGS. 11A and 11D, the first surface area of the first display region Q1 is greater than the second surface area of the second display region Q2. For example, for this condition, the first operation (the 3D preferential operation) is implemented.

In the examples of FIGS. 11C and 11F, the first surface area of the first display region Q1 is less than the second surface area of the second display region Q2. For example, for this condition, the second operation (the 2D preferential operation) is implemented.

In the examples of FIGS. 11B and 11E, the first surface area of the first display region Q1 is substantially the same as the second surface area of the second display region Q2. For example, for this condition, the third operation (the medium operation) is implemented.

In such cases as well, for example, the controller 150 implements one of the first operation or the second operation by switching between the operations by using the first surface area threshold recited above. The third operation may be further implemented by using the second surface area threshold.

FIGS. 12A and 12B are schematic plan views illustrating operations of the image display device according to the first embodiment.

In the example of FIG. 12A, the first display region Q1 is positioned at the center of the screen 400d. In such a case, the first operation is implemented.

On the other hand, in the example of FIG. 12B, the second display region Q2 is positioned at the center of the screen 400d. In such a case, the second operation is implemented.

Thus, the controller 150 implements the first operation when the first display region Q1 and a center 400c of the screen 400d overlap. The controller 150 implements the second operation when the second display region Q2 and the center 400c of the screen 400d overlap. Thus, the operation may be switched based on the position inside the screen 400d of the 3D image and the position inside the screen 400d of the 2D image.

FIGS. 13A and 13B are schematic plan views illustrating operations of the image display device according to the first embodiment.

In these examples, the display content is displayed in a window configuration.

In the example of FIG. 13A, the window that corresponds to the first display region Q1 is disposed on (frontward of) the window corresponding to the second display region Q2. In such a case, the first operation is implemented.

On the other hand, in the example of FIG. 13B, the window that corresponds to the second display region Q2 is disposed on (frontward of) of the window corresponding to the first display region Q1. In such a case, the second operation is implemented.

Thus, the controller 150 implements the first operation when a first content Qc1 displayed in the first display region Q1 is disposed on a second content Qc2 displayed in the second display region Q2. The controller 150 implements the second operation when the second content Qc2 is disposed on the first content Qc1. Thus, the operation may be switched based on the relative disposition (the vertical relationship) between the window of the 3D image and the window of the 2D image.

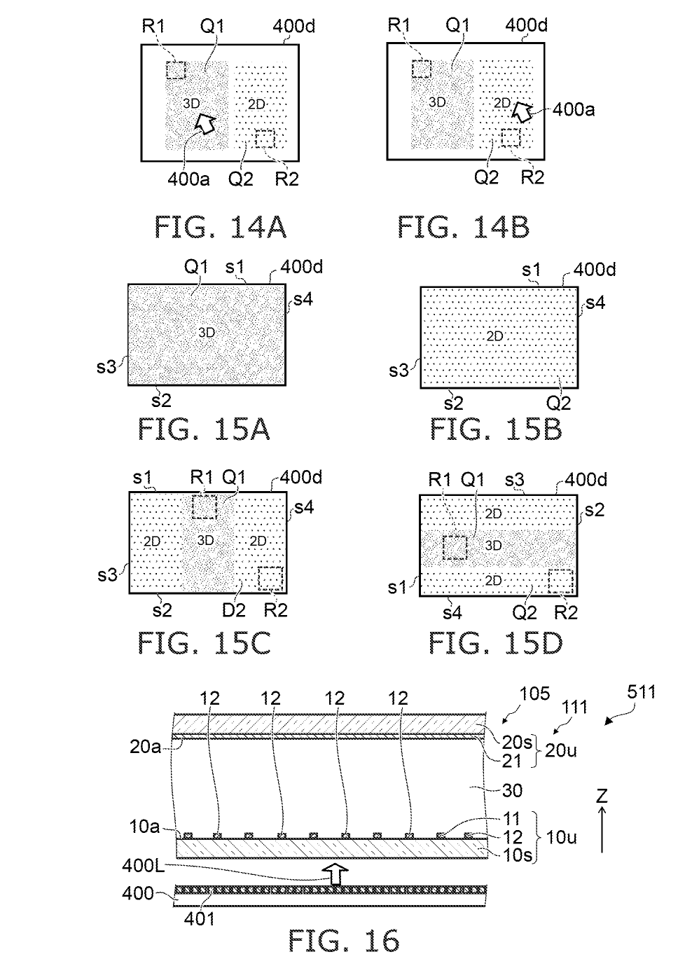

FIGS. 14A and 14B are schematic plan views illustrating operations of the image display device according to the first embodiment.

For example, the control signal Sc (an operation signal) is supplied from the user (the viewer) in these examples. For example, the control signal Sc is a signal from the operation of an input device (a mouse, a keyboard, a touch panel, etc.). An arrow 400a that is operated by the user is displayed in the screen 400d in the examples of these figures.

In the example of FIG. 14A, the arrow 400a is on the first display region Q1. The first operation is implemented when the user operates the input device to select the first display region Q1.

In the example of FIG. 14B, the arrow 400a is on the second display region Q2. The second operation is implemented when the user operates the input device to select the second display region Q2.

Thus, the controller 150 may selectively implement one of the first operation or the second operation based on the control signal Sc.

The control signal Sc may include information relating to the direction of the line of sight of the user (the viewer). For example, an imaging unit that images an image of the viewer is provided. The position inside the screen 400d given attention by the viewer can be estimated using the image of the viewer.

The first operation is implemented when the position that is given attention corresponds to the 3D image. The second operation is implemented when the position that is given attention corresponds to the 2D image.

Thus, the control signal Sc may include information relating to the line-of-sight direction of the viewer. In such a case, the controller 150 may selectively implement one of the first operation or the second operation based on the line-of-sight direction.

The operation may be selected based on two or more of the surface areas of the 3D image and the 2D image, the positions inside the screen 400d of the 3D image and the 2D image, or the vertical (frontward/rearward) arrangement of the content (the windows). In such a case, an evaluation value (a weight coefficient) may be calculated; and one of the first operation or the second operation may be implemented based on the evaluation value.

For example, the controller 150 may calculate the evaluation value according to at least one of the amount of character information included in the image information Id or the amount of three-dimensional display information included in the image information. The controller 150 may selectively implement one of the first operation or the second operation based on the evaluation value.

Thus, a configuration is used in which the mode of the voltage is selected according to whether the window selected by the user using an input I/F such as a mouse, etc., is the 3D display or the 2D display. However, even in the case where the window selected by the user is the 3D display, for example, it is favorable to execute the second operation or the third operation rather than the first operation if the size of the selection, e.g., the 3D window, is small. In such a case, the determination is performed using the weighting.

For example, the evaluation value E recited below is used.

E=D(window size)×α

The evaluation value E is determined using functions that provide a maximum value of 1. D(window size) is a function that decreases as the selected window becomes smaller. α is a function that is assigned the value of α1 when the 3D display is selected and is assigned the value of α2 when the 2D display is selected, where α2 is smaller than α1.

For example, a first threshold Th1 and a second threshold Th2 are predetermined.

The first operation (the 3D preferential operation) is performed when E>Th1.

The third operation (balanced) is performed when Th1≧W>Th2.

The second operation (the 2D preferential operation) is performed when Th2≧E.

As an example, the weight of the 3D display mode is set to 0.75 and the weight of the 2D display mode is set to 0.25 when the user performs the mode selection using a mouse on the screen. As an example, the surface area of the 3D display window is 20% of the entire surface area; and the surface area of the 2D display window is 80% of the entire surface area. In such a case, the evaluation value of the 3D display mode is (0.75+0.2)/2=0.45, and the evaluation value of the 2D display mode is (0.25+0.8)/2=0.55.

For example, 0.33 and 0.66 are set as the criteria for the evaluation value. Namely,

3D display mode: 0.66<E≦1

2D/3D balanced display mode: 0.33<E≦0.66

2D display mode: 0<E≦0.33.

Using these conditions, the 2D/3D balanced display mode is selected for the example recited above.

Although the evaluation value relating to the surface area of the window is calculated in the example recited above, an evaluation value relating to the position in the screen of the window may be calculated. Thus, the controller 150 may calculate a first evaluation values corresponding to the parameters including the surface area and position of the 3D region and a second evaluation value corresponding to the weight of the first mode and the weight of the second mode; and the controller 150 may select the multiple display modes according to the comparison result between the first and second evaluation values and predetermined thresholds.

For example, for a naked-eye 2D/3D switching display that partially switches between the 2D display and the 3D display, the embodiment may include a unit that calculates the weights of the 3D display and the 2D display according to the state of the 3D display content and may include a unit that determines, using the calculated values, a first voltage distribution to be applied in the 3D display unit region of a light ray control element provided on the display and a second voltage distribution to be applied in the 2D display unit region of the light ray control element and applies voltages corresponding to the first voltage distribution and the second voltage distribution in the 2D display unit region and the 3D display unit region.

In the embodiment, the selection of the first operation and the second operation may not be performed. Such an example will now be described.

FIGS. 15A to 15D are schematic plan views illustrating operations of the image display device according to the first embodiment.

In the example of FIG. 15A, the entire screen 400d of the image display unit 400 is the 3D image. In such a case, for example, the first condition Cv1 is employed without implementing the selecting operation. In other words, the first operation is implemented.

In the example of FIG. 15B, the entire screen 400d of the image display unit 400 is the 2D image. In such a case, for example, the potential of the first electrodes 11 of the optical unit 105 is set to be the same as the potential of the counter electrodes 21 (e.g., 0 V) without implementing the selecting operation.

In the example of FIG. 15C, the region of the 3D image extends vertically over the entire screen 400d. In such a case, crosstalk does not occur. In such a case, the potentials of the multiple counter electrodes 21 can be the same; and the potentials are set to be different between the first group G1 corresponding to the 3D image and the second group G2 corresponding to the 2D image. For example, the first condition Cv1 is employed. In other words, the first operation is implemented. Thereby, a refractive index distribution suited to the 3D image and refractive index characteristics suited to the 2D image are obtained.

In the example of FIG. 15D, the region of the 3D image extends horizontally over the entire screen 400d. In such a case as well, crosstalk does not occur. In such a case as well, for example, the first condition Cv1 is employed. In other words, the first operation is implemented.

For example, the controller 150 implements the first operation when the first display region Q1 contacts the first side Si and the second side s2 or when the second display region Q2 contacts the first side s1 and the second side s2. For example, the controller 150 implements the first operation when the first display region Q1 contacts the third side s3 and the fourth side s4 or when the second display region Q2 contacts the third side s3 and the fourth side s4.

FIG. 16 is a schematic cross-sectional view illustrating another image display device according to the first embodiment.

In a liquid crystal optical device 111 (an image display device 511) as shown in FIG. 16, multiple second electrodes 12 are further provided in the first substrate unit 10u. Otherwise, the liquid crystal optical device 111 is similar to the liquid crystal optical device 110.

The multiple second electrodes 12 are provided between the first substrate 10s and the liquid crystal layer 30. The multiple second electrodes 12 are disposed respectively between the multiple first electrodes 11.

For example, in the first operation, the controller 150 sets the absolute value of the potential difference between the first counter electrode 21a and at least one of the multiple second electrodes 12 (the absolute value of the potential difference of the second electrodes 12) to be small. For example, the absolute value is set to 0 V.

The positions that correspond to the first electrodes 11 correspond to, for example, the lens edges. The region between the multiple first electrodes 11 corresponds to, for example, the lens center. The second electrode 12 is provided at the position corresponding to the lens center; and the potential difference that is applied to the liquid crystal layer at this position is small compared to at the lens edges. Thereby, it is easy to control the characteristics of the refractive index distribution that is formed.

The controller 150 may set the absolute value of the potential difference of the second electrode 12 to be smaller than the first absolute value (the absolute value of the potential difference between the first counter electrode 21a and the multiple first electrodes 11).

### Second Embodiment

An image display device according to the embodiment includes the image display unit 400 and at least one of the liquid crystal optical device 110 or 111, or liquid crystal optical devices of modifications of the liquid crystal optical device 110 or 111. As the liquid crystal optical devices of the modifications, it is sufficient to use a configuration in which the refractive index distribution inside the liquid crystal layer is controlled by the applied voltage. The embodiment is realizable regardless of the electrode configuration and the applied voltage of the liquid crystal optical device 110 and the liquid crystal optical device 111. According to the embodiment, an image display device having high display quality can be provided by using a liquid crystal optical device having good optical characteristics.

### Third Embodiment

The embodiment relates to a control device that controls the liquid crystal optical device. The liquid crystal optical device includes the liquid crystal optical device and modifications of the liquid crystal optical device according to the first embodiment. The liquid crystal optical device includes the optical unit 105 recited above. The control device according to the embodiment corresponds to the controller 150 recited above.

The optical unit 105 includes the first substrate unit 10u, the second substrate unit 20u, and the liquid crystal layer 30. The control device is electrically connected to the multiple first electrodes 11 of the first substrate unit 10u, the first counter electrode 21a of the second substrate unit 20u, and the second counter electrode 21b.

The control device implements a selecting operation including selectively implementing one of the first operation or the second operation recited above based on at least one of the control signal Sc that is acquired or the image information Id input to the image display unit 400 that is stacked with the optical unit 105 and emits the image light.

According to the embodiment, a control device of a liquid crystal optical device having good optical characteristics can be provided.

According to the embodiments, a liquid crystal optical device having good optical characteristics, a control device of the liquid crystal optical device, and an image display device can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in liquid crystal optical devices and imaging devices such as optical units, substrate units, substrates, electrodes, liquid crystal layers, controllers, image display units, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all liquid crystal optical devices, control devices of the liquid crystal optical devices, and image display devices practicable by an appropriate design modification by one skilled in the art based on the liquid crystal optical devices, control devices of the liquid crystal optical devices, and image display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A liquid crystal optical device, comprising:
an optical unit including
a first substrate having a first surface including a first region and a second region,
a second substrate opposing the first substrate,
a plurality of first electrodes provided between the first substrate and the second substrate and arranged in a first direction parallel to the first surface, wherein a first group of the first electrodes overlaps the first region and a second group of the first electrodes overlaps the second region when projected onto the first surface,
a first counter electrode provided between the second substrate and the first electrodes, the first counter electrode and the first region overlapping when projected onto the first surface,
a second counter electrode provided between the second substrate and the first electrodes, the second counter electrode and the second region overlapping when projected onto the first surface, and
a liquid crystal layer provided between the first and the second substrates; and
a controller controlling a voltage applied to the first electrodes, the first counter electrode, and the second counter electrode,
the controller configured to perform a plurality of display modes including
a first mode including
forming a first lens in the liquid crystal layer by forming a first potential difference between the first group and the first counter electrode and
forming a second lens in the liquid crystal layer by forming a second potential difference between the second group and the second counter electrode,
a difference between a maximum value and a minimum value of a refractive index of the first lens being larger than a difference between a maximum value and a minimum value of a refractive index of the second lens,
and a second mode including
forming a third lens in the liquid crystal layer by forming a third potential difference between the first group and the first counter electrode and
forming a fourth lens in the liquid crystal layer by forming a fourth potential difference between the second group and the second counter electrode,
a difference between a maximum value and a minimum value of a refractive index of the third lens being larger than a difference between a maximum value and a minimum value of a refractive index of the fourth lens.

2. The device according to claim 1, wherein the difference between the maximum value and the minimum value of the refractive index of the liquid crystal layer of the first lens is larger than the difference between the maximum value and the minimum value of the refractive index of the liquid crystal layer of the third lens.

3. The device according to claim 1, wherein
a dielectric anisotropy of a liquid crystal included in the liquid crystal layer is positive,
a first absolute value of the first potential difference is greater than a second absolute value of the second potential difference,
a third absolute value of the third potential difference is greater than the fourth absolute value of the fourth absolute value, and
the first absolute value is greater than the third absolute value.

4. The device according to claim 1, wherein
the image display unit includes a screen including a first display region and a second display region, the first display region emitting a first image light including a plurality of parallax information, the second display region emitting a second image light not including parallax information,
the first region and at least a portion of the first display region overlap when projected onto the first surface, and
the second region and at least a portion of the second display region overlap when projected onto the first surface.

5. The device according to claim 4, wherein
the screen has a first side, a second side, a third side, and a fourth side, the second side being separated from the first side, the third side intersecting the first side and the second side, the fourth side being separated from the third side and intersecting the first side and the second side,
a first portion of the first display region is disposed between the second display region and the first side, and
a second portion of the first display region is disposed between the second display region and the third side.

6. The device according to claim 4, wherein
the screen has a first side, a second side, a third side, and a fourth side, the second side being separated from the first side, the third side intersecting the first side and the second side, the fourth side being separated from the third side and intersecting the first side and the second side,
a first portion of the second display region is disposed between the first display region and the first side, and
a second portion of the second display region is disposed between the first display region and the third side.

7. The device according to claim 4, wherein
the screen has a first side, and a second side separated from the first side, and
the controller implements the first mode when the first display region contacts the first side and the second side or when the second display region contacts the first side and the second side.

8. The device according to claim 4, wherein
the controller implements the first mode when a ratio of a first surface area of the first display region to a second surface area of the second display region is greater than a first surface area threshold, and
the controller implements the second mode when the ratio is not more than the first surface area threshold.

9. The device according to claim 4, wherein
the controller implements the first mode when the first display region and a center of the screen overlap, and
the controller implements the second mode when the second display region and the center overlap.

10. The device according to claim 4, wherein
the controller implements the first mode when a first content displayed in the first display region is disposed on a second content displayed in the second display region, and
the controller implements the second mode when the second content is disposed on the first content.

11. The device according to claim 1, wherein the controller calculates a first evaluation value corresponding to parameters including a surface area of the 3D region and a position of the 3D region, calculates a second evaluation value corresponding to a weight of the first mode and a weight of the second mode, and selects the plurality of display modes according to a comparison result between a predetermined threshold and the first and second evaluation values.

12. The device according to claim 1, wherein
the controller further implements a third mode,
the third mode includes:
forming a fifth lens by forming a potential difference of a fifth absolute value between the first group and the first counter electrode; and
forming a sixth lens by forming a potential difference of a sixth absolute value between the second group and the second counter electrode, the sixth absolute value being different from the fifth absolute value,
a difference between a maximum value and a minimum value of a refractive index of the fifth lens is larger than a difference between a maximum value and a minimum value of a refractive index of the sixth lens, and
the fifth absolute value is between the first absolute value and the third absolute value.

13. The device according to claim 12, wherein
the controller implements the first mode when a ratio of a first surface area of the first display region to a second surface area of the second display region is greater than a first surface area threshold,
the controller implements the third mode when the ratio is not more than the first surface area threshold and the ratio is greater than a second threshold, the second threshold being less than the first surface area threshold, and
the controller implements the second mode when the ratio is not more than the second surface area threshold.

14. The device according to claim 11, wherein
the third mode includes:
setting the first group to a third electrode high potential,
setting the first counter electrode to a third counter low potential,
setting the second group to a third electrode low potential, and
setting the second counter electrode to a third counter high potential, and
the controller includes a potential generator generating the third electrode high potential, the third counter low potential, the third electrode low potential, and the third counter high potential.

15. The device according to claim 1, wherein
the first mode includes:
setting the first group to a first electrode high potential;
setting the first counter electrode to a first counter low potential;
setting the second group to a first electrode low potential; and
setting the second counter electrode to a first counter high potential,
the second mode includes:
setting the first group to a second electrode high potential;
setting the first counter electrode to a second counter low potential;
setting the second group to a second electrode low potential; and
setting the second counter electrode to a second counter high potential, and
the controller includes a potential generator generating the first electrode high potential, the first counter low potential, the first electrode low potential, the first counter high potential, the second electrode high potential, the second counter low potential, the second electrode low potential, and the second counter high potential.

16. The device according to claim 1, wherein the controller implements the first mode or the second mode based on a control signal.

17. The device according to claim 16, wherein
the control signal includes information relating to a line-of-sight direction of a viewer, and
the controller implements the first mode or the second mode based on the line-of-sight direction.

18. The device according to claim 1, wherein
the controller selects the display mode based on image information inputted to an image display unit stacked with the optical unit, the image display unit emitting an image light, and calculates an evaluation value corresponding to at least one of an amount of character information included in the image information or an amount of three-dimensional display information included in the image information, and
the controller implements the first mode or the second mode based on the evaluation value.

19. The device according to claim 1, wherein
the first substrate unit further includes a plurality of second electrodes provided between the first substrate and the liquid crystal layer,
the second electrodes are disposed respectively between the first electrodes, and
the controller sets, in the first mode, an absolute value of a potential difference between the first counter electrode and at least one of the second electrodes to be less than the first absolute value.

20. An image display device, comprising:
a liquid crystal optical device; and
a image display unit,
the liquid crystal optical device, including:
an optical unit including
a first substrate having a first surface including a first region and a second region,
a second substrate opposing the first substrate,
a plurality of first electrodes provided between the first substrate and the second substrate and arranged in a first direction parallel to the first surface, wherein a first group of the first electrodes overlaps the first region and a second group of the first electrodes overlaps the second region when projected onto the first surface,
a first counter electrode provided between the second substrate and the first electrodes, the first counter electrode and the first region overlapping when projected onto the first surface,
a second counter electrode provided between the second substrate and the first electrodes, the second counter electrode and the second region overlapping when projected onto the first surface, and
a liquid crystal layer provided between the first and the second substrates; and
a controller controlling a voltage applied to the first electrodes, the first counter electrode, and the second counter electrode,
the controller configured to perform a plurality of display modes
including,
a first mode including
forming a first lens in the liquid crystal layer by forming a first potential difference between the first group and the first counter electrode and
forming a second lens in the liquid crystal layer by forming a second potential difference between the second group and the second counter electrode,
a difference between a maximum value and a minimum value of a refractive index of the first lens being larger than a difference between a maximum value and a minimum value of a refractive index of the second lens,
and a second mode including
forming a third lens in the liquid crystal layer by forming a third potential difference between the first group and the first counter electrode and
forming a fourth lens in the liquid crystal layer by forming a fourth potential difference between the second group and the second counter electrode,
a difference between a maximum value and a minimum value of a refractive index of the third lens being larger than a difference between a maximum value and a minimum value of a refractive index of the fourth lens.

21. A control device to control a liquid crystal optical device,
the liquid crystal optical device including
an optical unit including
a first substrate having a first surface including a first region and a second region,
a second substrate opposing the first substrate,
a plurality of first electrodes provided between the first substrate and the second substrate and arranged in a first direction parallel to the first surface, wherein a first group of the first electrodes overlaps the first region and a second group of the first electrodes overlaps the second region when projected onto the first surface,
a first counter electrode provided between the second substrate and the first electrodes, the first counter electrode and the first region overlapping when projected onto the first surface,
a second counter electrode provided between the second substrate and the first electrodes, the second counter electrode and the second region overlapping when projected onto the first surface, and
a liquid crystal layer provided between the first and the second substrates;
the control device controlling a voltage applied to the first electrodes, the first counter electrode, and the second counter electrode, and
the control device configured to perform a plurality of display modes including,
a first mode including
forming a first lens in the liquid crystal layer by forming a first potential difference between the first group and the first counter electrode and
forming a second lens in the liquid crystal layer by forming a second potential difference between the second group and the second counter electrode,
a difference between a maximum value and a minimum value of a refractive index of the first lens being larger than a difference between a maximum value and a minimum value of a refractive index of the second lens, and
a second mode including
forming a third lens in the liquid crystal layer by forming a third potential difference between the first group and the first counter electrode and
forming a fourth lens in the liquid crystal layer by forming a fourth potential difference between the second group and the second counter electrode,
a difference between a maximum value and a minimum value of a refractive index of the third lens being larger than a difference between a maximum value and a minimum value of a refractive index of the fourth lens.
